(19) United States
(12) Patent Application Publication
(10) Pub. No.: US 2009/0137715 A1
(43) Pub. Date: May 28, 2009

(54) Copolymers of olefinically unsaturated monomers, their preparation and use

(75) Inventors: Horst Hintze-Bruning, Munster (DE); Dirk Schmelter, Munster (DE)

Correspondence Address: Mary E. Golota;Cantor Colburn LLP, 201 W. Big Beaver Road, Suite 1101, Troy, MI, 48084, US

(73) Assignee: BASF COATINGS AG, Munster (DE)

(21) Appl. No.: 12/294,362

(22) PCT Filed: Jan. 25, 2007
(86) PCT No.: PCT/EP07/00612

§ 371 Date: Sep. 24, 2008

(30) Foreign Application Priority Data
Mar. 24, 2006 (DE) 10 2006 014 088.5

(51) Int. Cl. C08K 3/30; C08F 212/06; C08F 220/00; C08F 228/02; C08F 216/12; C08F 222/02; C08F 220/10; C08F 210/00; C08F 2/16; C08L 25/02

(52) U.S. Cl. 524/423; 526/347; 526/317.1; 526/286; 526/332; 526/310; 526/318.2; 526/328.5; 526/348; 524/849; 524/577; 977/773; 977/902

(57) ABSTRACT

Disclosed herein is a copolymer (A) of olefinically unsaturated monomers (a), prepared by single-stage or multistage controlled free-radical copolymerization in an aqueous medium of monomers comprising: (a1) an olefinically unsaturated monomer comprising a chelate-forming group; and (a2) an olefinically unsaturated monomer different from the olefinically unsaturated monomer (a1), and selected from the group consisting of: (a21) monomers of the general formula I: R¹R²C═CR³R⁴ (I), wherein R¹, R², R³, and R⁴ are independently hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of R¹, R², R³, and R⁴ are substituted or unsubstituted aryl, arylalkyl or arylcycloalkyl radicals; (a22) an olefinically unsaturated terpene hydrocarbon; and (a23) a dimeric alpha-alkylvinylaromatic. Also disclosed is a method of inhibiting the crystallization of nanoparticles and/or dispersing nanoparticles, and compositions comprising crystallization inhibited nanoparticles and/or dispersed nanoparticles.

### FIELD OF THE INVENTION

The present invention relates to new copolymers of olefinically unsaturated monomers. The present invention also relates to a new process for preparing copolymers of olefinically unsaturated monomers. The present invention relates not least to the use of the new copolymers of olefinically unsaturated monomers, and of the copolymers of olefinically unsaturated monomers that are prepared by the new process.

### PRIOR ART

Copolymers of olefinically unsaturated monomers that are preparable by controlled single-stage or multistage free-radical copolymerization of
at least one first olefinically unsaturated monomer and
at least one second olefinically unsaturated monomer, which is different from the first olefinically unsaturated monomer and has the general formula I

R¹R²C═CR³R⁴ (1),

in which the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals,

in an aqueous medium are known from German patent application DE 101 26 651 A1. They are used as emulsifiers in the preparation of pigmented powdercoating suspensions (powder slurries). They are preferably introduced via pigment pastes or pigment preparations into the aqueous media of the powdercoating suspensions. The pigment pastes or pigment preparations may have a particularly high level of nanoparticles, especially hydrophilic oxidic nanoparticles based on silica, alumina, zinc oxide, zirconium oxide, and the polyacids and heteropolyacids of transition metals, preferably of molybdenum and tungsten. The nanoparticles have a primary particle size <50 nm.

Whether these known copolymers are able to act as crystallization inhibitors and dispersants with respect to barium sulfate nanoparticles, particularly in order to stabilize primary barium sulfate particles, is not apparent from the German patent application.

### Problem Addressed by the Invention

The object on which the present invention was based was that of finding new copolymers which are preparable by the controlled free-radical copolymerization of olefinically unsaturated monomers and which are outstandingly suitable dispersants for nanoparticles. In particular they ought to be outstandingly suitable crystallization inhibitors and/or dispersants for barium sulfate nanoparticles. They ought not least to be outstandingly suitable for stabilizing primary barium sulfate particles.

A further object of the present invention was to find a new process for preparing copolymers of olefinically unsaturated monomers by controlled free-radical copolymerization in an aqueous medium, said process being implementable easily, reliably, and with very good reproducibility.

The aqueous dispersions of the new copolymers prepared or preparable by the controlled free-radical copolymerization of olefinically unsaturated monomers ought to be capable of stably dispersing particularly large amounts of nanoparticles, in particular of barium sulfate nanoparticles.

The new nanoparticle dispersions ought to be outstandingly suitable for producing new materials curable physically, thermally, with actinic radiation, and both thermally and with actinic radiation, especially new coating materials, adhesives, and sealants, and also precursors to moldings and films.

The new curable materials ought to provide new thermoplastic or thermoset materials, especially new coatings, adhesive layers, seals, moldings, and films, having very good performance properties.

### Solution Provided by the Invention

Found accordingly have been the new copolymers (A) of olefinically unsaturated monomers (a), preparable by single-stage or multistage controlled free-radical copolymerization in an aqueous medium of
(a1) at least one olefinically unsaturated monomer containing at least one chelate-forming group and
(a2) at least one olefinically unsaturated monomer different from olefinically unsaturated monomer (a1) and selected from the group consisting of
   (a21) monomers of the general formula I

R¹R²C═CR³R⁴ (1),

in which the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals,
(a22) olefinically unsaturated terpene hydrocarbons, and
(a23) dimeric alpha-alkylvinylaromatics.

The new copolymers (A) of olefinically unsaturated monomers (a) are referred to below as “copolymers (A) of the invention”.

Also found has been the new process for preparing the copolymers (A) of the invention, which involves subjecting
(a1) at least one olefinically unsaturated monomer containing at least one chelate-forming group and
(a2) at least one olefinically unsaturated monomer different from olefinically unsaturated monomer (a1) and selected from the group consisting of
   (a21) monomers of the general formula I

R¹R²C═CR³R⁴ (1),

in which the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals,
(a22) olefinically unsaturated terpene hydrocarbons, and
(a23) dimeric alpha-alkylvinylaromatics

to controlled free-radical copolymerization in an aqueous medium.

The new process for preparing the copolymers (A) of the invention is referred to below as “process of the invention”.

Found not least has been the new use of the copolymers (A) of the invention and of the copolymers (A) of the invention prepared by the process of the invention as dispersants for nanoparticles, this being referred to below as “inventive use”.

Additional subject matter of the invention will become apparent from the description.

### ADVANTAGES OF THE INVENTION

In the light of the prior art it was surprising and unforeseeable for the skilled worker that the object on which the present invention was based could be achieved by means of the copolymers (A) of the invention, the process of the invention, and the inventive use.

In particular it was surprising that the copolymers (A) of the invention were outstandingly suitable dispersants for nanoparticles. In particular they were outstandingly suitable crystallization inhibitors and/or dispersants for barium sulfate nanoparticles. Not least they were suitable outstandingly for stabilizing primary barium sulfate particles.

Additionally it was surprising that the process of the invention was implementable particularly simply, reliably, and with very good reproducibility.

The resulting new aqueous dispersions of the copolymers (A) of the invention were capable of stably dispersing particularly large amounts of nanoparticles, especially of barium sulfate nanoparticles.

The resulting new nanoparticle dispersions were outstandingly suitable for producing new materials curable physically, thermally, with actinic radiation, and both thermally and with actinic radiation, especially new coating materials, adhesives, and sealants, and also precursors to moldings and films.

The curable materials of the invention provided new thermoplastic or thermoset materials, especially new coatings, adhesive layers, seals, moldings, and films, having very good performance properties.

### DETAILED DESCRIPTION OF THE INVENTION

The copolymers (A) of the invention are preparable by subjecting at least
(a1) at least one, especially one, olefinically unsaturated monomer containing at least one, especially one, chelate-forming group and
(a2) at least one, especially one, olefinically unsaturated monomer different from olefinically unsaturated monomer (a1) and selected from the group consisting of
   (a21) monomers of the general formula I

R¹R²C═CR³R⁴ (1),

in which the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals,
(a22) olefinically unsaturated terpene hydrocarbons, and
(a23) dimeric alpha-alkylvinylaromatics, and also, if desired,
(a3) at least one olefinically unsaturated monomer different from the monomers (a1) and (a2)

to controlled free-radical copolymerization in an aqueous medium.

The olefinically unsaturated monomers (a1) here contain at least one, especially one, chelate-forming group, capable of forming what are called chelates (cf. Rompp Online, Georg Thieme Verlag, Stuttgart, New York, 2005, “chelates”).

The chelate-forming group of the monomer (a1) is preferably at least bidentate, in particular bidentate (cf. Rompp Online 2005, “chelates”).

The chelate-forming group preferably contains at least two, especially two, atomic groupings which act as electron donors. Via these atomic groupings the monomers (a1) are capable of forming coordination compounds with metal atoms or metal cations.

Particular preference is given to using atomic groupings selected from the group consisting of carbonyl groups (>C═O), thiocarbonyl groups (>C═S), ether groups (—CH₂—O—CH₂—), thioether groups (—CH₂—S—CH₂—), primary, secondary, and tertiary amino groups (≧C—NR⁵₂) with R=hydrogen atom or alkyl radical having 1 to 6 carbon atoms, primary and secondary imino groups (>C═NR⁵) with R⁵=hydrogen atom or alkyl radical having 1 to 6 carbon atoms, oxime groups (>C═N—O—H), imino ether groups (>C═N—O—R⁶) with R⁶=alkyl radical having 1 to 10 carbon atoms or cycloalkyl radical having 4 to 10 carbon atoms, and also primary, secondary, and tertiary phosphine groups (—PR⁷₂) with R⁷=hydrogen atom or alkyl radical having 1 to 6 carbon atoms, cycloalkyl radical having 4 to 10 carbon atoms or aryl radical having 6 to 10 carbon atoms.

With very particular preference the atomic groupings are carbonyl groups (>C═O).

In particular the chelate-forming groups are 1,3-dicarbonyl groups, especially acetoacetoxy groups (CH₃—C(O)—CH₂—C(O)—O—).

The olefinically unsaturated groups of the monomers (a1) are preferably selected from the group consisting of (meth)acrylate, ethacrylate, crotonate, cinnamate, vinyl ether, vinyl ester, dicyclopentadienyl, norbornenyl, isoprenyl, isopropenyl, allyl or butenyl groups, dicyclopentadienyl ether, norbornenyl ether, isoprenyl ether, isopropenyl ether, allyl ether or butenyl ether groups, or dicyclopentadienyl ester, norbornenyl ester, isoprenyl ester, isopropenyl ester, allyl ester or butenyl ester groups.

In particular the olefinically unsaturated groups are (meth)acrylate groups.

Here and below, the term “(meth)acrylate groups” is used as an abbreviated version of “acrylate groups and/or methacrylate groups”.

In a monomer (a1) the chelate-forming group or chelate-forming groups is or are attached to the olefinically unsaturated group or olefinically unsaturated groups via at least one covalent bond or via at least one divalent, especially divalent, linking group.

Preferably in the monomer (a1) a chelate-forming group is linked to an olefinically unsaturated group via a divalent linking group.

Suitable divalent linking groups include basically all divalent organic groups which are inert.

In the context of the present invention, “inert” means that the divalent linking groups in question do not inhibit the controlled free-radical copolymerization in the preparation of the copolymers (A) of the invention and do not, before, during or after the preparation of the copolymers (A) of the invention, initiate any unwanted secondary reactions, such as decomposition reactions, for example.

The divalent linking groups are preferably groups which include or are composed of alkylene groups, cycloalkylene groups and/or arylene groups. Preference is given to using alkylene groups, with particular preference alkylene groups having 2 to 6 carbon atoms, especially 1,2-ethylene groups.

Examples of especially suitable monomers (a1) are 2-(acetoacetoxy)ethyl methacrylate and acrylate, especially the methacrylate, which is sold under the brand name Lonzamon® AAEMA by Lonza.

The amount of olefinically unsaturated monomer (a1) used in the controlled free-radical copolymerization may vary very widely and can therefore be adapted outstandingly to the requirements of the case in hand. The amount of (a1), based in each case on the sum of the monomers (a1) and (a2), is preferably 1% to 99.9%, more preferably 2% to 99%, with particular preference 3% to 98%, and in particular 5% to 97% by weight.

As monomers (a2) it is possible to use monomers (a21) of the general formula I.

In the general formula I the radicals R¹, R², R³, and R⁴ are each independently hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals.

Examples of suitable alkyl radicals are methyl, ethyl, propyl, isopropyl, n-butyl, isobutyl, tert-butyl, amyl, hexyl or 2-ethylhexyl.

Examples of suitable cycloalkyl radicals are cyclobutyl,cyclopentyl or cyclohexyl.

Examples of suitable alkylcycloalkyl radicals are methylene cyclohexane, ethylene cyclohexane or propane-1,3-diylcyclohexane.

Examples of suitable cycloalkylalkyl radicals are 2-, 3- or 4-methyl-, -ethyl-, -propyl- or -butylcyclohex-1-yl.

Examples of suitable aryl radicals are phenyl, naphthyl or biphenylyl.

Examples of suitable alkylaryl radicals are benzyl or ethylene- or propane-1,3-diylbenzene.

Examples of suitable cycloalkylaryl radicals are 2-, 3- or 4-phenylcyclohex-1-yl.

Examples of suitable arylalkyl radicals are 2-, 3- or 4-methyl-, -ethyl-, -propyl- or -butylphen-1-yl.

Examples of suitable arylcycloalkyl radicals are 2-, 3- or 4-cyclohexylphen-1-yl.

The above-described radicals R¹, R², R³, and R⁴ may be substituted. For this purpose it is possible to use electron-withdrawing or electron-donating atoms or organic radicals.

Examples of suitable substituents are halogen atoms, especially chlorine and fluorine, nitrile groups, nitro groups, partially or fully halogenated, especially chlorinated and/or fluorinated, alkyl, cycloalkyl, alkylcycloalkyl, cycloalkylalkyl, aryl, alkylaryl, cycloalkylaryl, arylalkyl and arylcycloalkyl radicals, including those exemplified above, especially tert-butyl; aryloxy, alkyloxy, and cycloalkyloxy radicals, especially phenoxy, naphthoxy, methoxy, ethoxy, propoxy, butyloxy or cyclohexyloxy; arylthio, alkylthio, and cycloalkylthio radicals, especially phenylthio, naphthylthio, methylthio, ethylthio, propylthio, butylthio or cyclohexylthio; hydroxyl groups; and/or primary, secondary and/or tertiary amino groups, especially amino, N-methylamino, N-ethylamino, N-propylamino, N-phenylamino, N-cyclohexylamino, N,N-dimethylamino, N,N-diethylamino, N,N-dipropylamino, N,N-diphenylamino, N,N-dicyclohexylamino, N-cyclohexyl-N-methylamino or N-ethyl-N-methylamino.

Examples of monomers (a21) used with particular preference in accordance with the invention are diphenylethylene, dinaphthaleneethylene, cis or trans-stilbene, vinylidenebis(4-N,N-dimethylaminobenzene), vinylidenebis(4-aminobenzene) or vinylidenebis(4-nitro-benzene).

The monomers (a21) can be used individually or as a mixture of at least two monomers (a21).

In respect of the reaction regime and the properties of the resulting copolymers (A) very particular advantage attaches to diphenylethylene (a21), which is therefore used with very particular preference as monomer (a21) of the general formula I.

Further it is possible as monomers (a2) to use olefinically unsaturated terpene hydrocarbons (a22).

The olefinically unsaturated terpene hydrocarbons (a22) are customary and known, naturally occurring or synthetic compounds. It is preferred to use olefinically unsaturated terpene hydrocarbons containing no reactive functional groups, such as hydroxyl groups, amino groups or carbonyl groups.

The olefinically unsaturated terpene hydrocarbon (a22) is preferably selected from the group consisting of acyclic diterpenes, monocyclic terpenes, bicyclic terpenes, acyclic sesquiterpenes, monocyclic sesquiterpenes, bicyclic sesquiterpenes, tricyclic sesquiterpenes, acyclic diterpenes, monocyclic diterpenes, and tricyclic diterpenes.

With particular preference the terpene hydrocarbon (a22) is selected from the group consisting of acyclic monoterpenes, monocyclic terpenes, and bicyclic terpenes.

With very particular preference the terpene hydrocarbon (a22) is selected from the group consisting of ocimene, myrcene, the menthenes, the menthadienes, alpha-pinene, and beta-pinene.

In particular the menthadienes (a22) are selected from the group consisting of alpha-terpinene, beta-terpinene, gamma-terpinene, terpinolene, alpha-phellandrene, beta-phellandrene, limonene, and dipentene.

gamma-Terpinene is used especially as monomer (a22).

As monomers (a2) it is possible not least to use dimeric alpha-alkylvinylaromatics (a23) and preferably dimeric alpha-alkylstyrenes (a23), especially dimeric alpha-methylstyrene (a23).

In the controlled free-radical copolymerization the amount of monomers (a2) used may vary widely and so can be adapted outstandingly to the requirements of the case in hand. The amount of (a2), based in each case on the sum of the monomers (a1) and (a2), is preferably 0.1% to 99%, more preferably 1% to 98%, with particular preference 2% to 97%, and in particular 3% to 95% by weight.

The above-described olefinically unsaturated monomers (a1) and (a2) may additionally be copolymerized with at least one different olefinically unsaturated monomer (a3). It is preferred to use at least two olefinically unsaturated monomers (a3).

The structure of the olefinically unsaturated monomers (a3) may vary greatly. What is essential is that the olefinically unsaturated monomers (a3) can be subjected to controlled free-radical copolymerization with the above-described olefinically unsaturated monomers (a1) and (a2) without causing any unwanted secondary reactions.

The olefinically unsaturated monomers (a3) may either contain or be free from any of a very wide variety of the functional groups. Where they do contain functional groups, these groups should not enter into any unwanted physical or chemical interactions with the chelate-forming groups of the monomers (a1) and should neither inhibit nor accelerate the controlled free-radical copolymerization. The skilled worker is therefore able to select suitable olefinically unsaturated monomers (a3) on the basis of his or her general knowledge with ease and, where appropriate, with the aid of a few rangefinding experiments.

The olefinically unsaturated monomers (a3) serve to vary the profile of properties of the copolymers (A) of the invention. On account of the multiplicity of suitable olefinically unsaturated monomers (a3) the profile of properties of the copolymers (A) of the invention can easily be given extremely broad variation and be adapted outstandingly to the requirements of the particular end use, which represents a very particular advantage of the copolymers (A) of the invention.

Examples of suitable olefinically unsaturated monomers (a3) are known from German patent application DE 101 26 651 A1, pages 4 to 5, paragraphs [0024] and [0025].

Within the bounds of the process of the invention the copolymers (A) of the invention are prepared by the controlled free-radical copolymerization of the above-described olefinically unsaturated monomers (a1) and (a2), and also, if desired, (a3), preferably (a1), (a2), and (a3).

The olefinically unsaturated monomers (a1), (a2), and (a3) are preferably used in amounts, based in each case on (a1), (a2), and (a3), of
1% to 30%, preferably 2% to 20%, and in particular 5% to 15% by weight of (a1),
0.1% to 25%, preferably 1% to 15%, and in particular 2% to 10% by weight of (a2), and
45% to 98.9%, preferably 65% to 97%, and in particular 75% to 93% by weight of (a3).

The monomers (a1), (a2), and, if desired, (a3) are reacted with one another in the presence of at least one free-radical initiator to give the copolymer (A). Examples of initiators that can be used include the following: dialkyl peroxides, such as di-tert-butyl peroxide or dicumyl peroxide; hydroperoxides, such as cumene hydroperoxide or tert-butyl hydroperoxide; peresters, such as tert-butyl perbenzoate, tert-butyl perpivalate, tert-butyl per-3,5,5-trimethylhexanoate or tert-butyl per-2-ethylhexanoate; potassium, sodium or ammonium peroxodisulfate; azo dinitriles such as azobisisobutyronitrile; C—C-cleaving initiators such as benzpinacol silyl ethers; or a combination of a nonoxidizing initiator with hydrogen peroxide.

It is preferred to add comparatively large amounts of free-radical initiator, the fraction of the initiator as a proportion of the reaction mixture, based in each case on the total amount of the monomers (a1), (a2), and, if desired, (a3) and of the initiator, being preferably 0.5% to 50%, with particular preference 1% to 20%, and in particular 2% to 15% by weight.

The weight ratio of initiator to the monomers (a2) is preferably 4:1 to 1:4, with particular preference 3:1 to 1:3, and in particular 2:1 to 1:2. Further advantages result if the initiator is used in excess within the stated limits.

The free-radical copolymerization is preferably carried out in customary and known apparatus, especially stirred tanks, tube reactors or Taylor reactors, the Taylor reactors being designed such that the conditions of Taylor flow are met over the entire length of the reactor, even if as a result of the copolymerization there is a sharp change—in particular an increase—in the kinematic viscosity of the reaction medium.

The copolymerization is carried out in an aqueous medium.

The aqueous medium comprises substantially water. The aqueous medium here may include, in minor amounts, organic solvents and/or other dissolved solid, liquid or gaseous, organic and/or inorganic compounds of low and/or high molecular mass, provided that these compounds do not adversely affect, let alone inhibit, the copolymerization. In the context of the present invention the term “minor amount” refers to an amount which does not deprive the aqueous medium of its aqueous character. The aqueous medium, however, may also be water alone.

The copolymerization is preferably carried out in the presence of at least one base. Particular preference is given to bases of low molecular mass, such as sodium hydroxide solution, potassium hydroxide solution, diethanolamine, ammonia, triethanolamine, mono-, di-, and triethylamine, and/or dimethylethanolamine, especially ammonia and/or di- and/or triethanolamine.

The copolymerization is advantageously carried out at temperatures above room temperature and below the lowest decomposition temperature of the respective monomers (a1), (a2), and, if desired, (a3), used, the temperature range selected being preferably 10 to 150° C., with very particular preference 70 to 120° C., and in particular 80 to 110° C.

When particularly volatile monomers (a1), (a2), and, if desired, (a3) are used it is also possible to carry out the copolymerization under superatmospheric pressure, preferably under 1.5 to 3000 bar, more preferably 5 to 1500 bar, and in particular 10 to 1000 bar.

With regard to number-average and mass-average molecular weights Mₙ and M_{w} and also the molecular weight distribution M_{w}/Mₙ there are no restrictions whatsoever imposed on the copolymers (A) of the invention.

Advantageously, however, the copolymerization is performed in such a way as to result in a molecular weight distribution M_{w}/Mₙ, as measured by gel permeation chromatography using polystyrene as standard, of ≦4, preferably ≦2, and in particular ≦1.5, and also, in certain cases, ≦1.3.

The molecualr weights Mₙ and M_{w} of the copolymers (A) can be controlled within wide limits through the selection of the ratio of monomer (a1), (a2), and, if desired, (a3) to free-radical initiator. In this context the amount of monomer (a2), in particular, determines the molecular weight, specifically such that the greater the fraction of monomer (a2) the lower the molecular weight obtained.

Preferably the number-average molecular weight Mₙ is 1000 to 100000 daltons, more preferably 1500 to 50 000 daltons, and in particular 2000 to 25 000 daltons.

In the process of the invention the copolymers (A) of the invention are obtained in the form of fine dispersions, referred to below as “dispersions (A) of the invention”. The particle size of the dispersions (A) of the invention may vary widely. Its average particle size d₅₀ as determined by photon correlation spectroscopy or laser diffraction is preferably 1 nm to 500 μm.

The dispersions (A) of the invention can be supplied as they are for the inventive use. However, the copolymers (A) of the invention can be isolated from them by means of customary and known methods, such as freeze drying, for example, and can be used in the form of liquid or solid resins (A). The form in which the copolymers (A) of the invention are inventively used is guided by the requirements of the case in hand.

The copolymers (A) of the invention and the dispersions (A) of the invention can be supplied with advantage to all end uses that are customary and known for copolymers and dispersions.

With preference, however, they are used as crystallization inhibitors and/or dispersants for nanoparticles, particularly in the context of the preparation of dispersions of nanoparticles.

Nanoparticles which can be used are all customary and known nanoparticles. They are preferably selected from the group consisting of metals, compounds of metals, and organic compounds, especially compounds of metals.

The metals are preferably selected from the group consisting of ruthenium, osmium, cobalt, rhodium, iridium, nickel, palladium, platinum, silver, and gold.

The metal compounds are preferably selected from the compounds of metals of main groups two to five, of transition groups three to six and also of transition groups one and two of the Periodic Table of the Elements, and also the lanthanoids, and more preferably from the group consisting of barium, boron, aluminum, gallium, silicon, germanium, tin, arsenic, antimony, silver, zinc, titanium, zirconium, hafnium, vanadium, niobium, tantalum, molybdenum, tungsten, and cerium. Barium is used in particular.

The compounds of the metals are preferably oxides, oxide hydrates, sulfates, hydroxides or phosphates, especially sulfates.

Examples of suitable organic compounds are lignins and starches.

Use is made in particular of barium sulfate nanoparticles.

The nanoparticles have a primary particle size of preferably <50 nm, more preferably 5 to 50 nm, in particular 10 to 30 nm, as measured by . . . (insert measurement method where appropriate: “disk centrifuge” used by Solvay (quasi=ultracentrifuge) and/or light scattering and/or electron micrographs).

With very particular advantage the copolymers (A) of the invention and their dispersions (A) are used as crystallization inhibitors and dispersants in the preparation of deagglomerated barium sulfate nanoparticles by precipitation of barium ions with sulfate ions, as described analogously in, for example, German patent application DE 102004010201 A1, page 6 paragraph [0043] to page 7 paragraph [0050]. “Deagglomerated” means that the average secondary particle size is not more than 30% greater than the average primary particle size.

The barium sulfate nanoparticle dispersions of the invention have a particularly high barium sulfate nanoparticle content of up to 20% by weight, based on the dispersion.

The deagglomerated barium sulfate nanoparticles of the invention can be isolated from their dispersions of the invention, by means of freeze drying, for example, and can be stored and transported without problems prior to their further use. In this context it proves to be a very particular advantage of the deagglomerated barium sulfate nanoparticles of the invention that, on account of the presence therein of copolymers (A) of the invention, they can be redispersed with particular ease in water and/or organic solvents.

The nanoparticle content of the mixture made up of the deagglomerated barium sulfate nanoparticles of the invention and the copolymers (A) of the invention is preferably 10% to 90%, more preferably 15% to 85%, and in particular 20% to 80% by weight, and the amount of (A) therein is preferably 90% to 10%, more preferably 85% to 15%, and in particular 80% to 20% by weight, based in each case on the mixture.

The above-described nanoparticles of the invention comprising the copolymers (A) of the invention are used preferably, particularly in the form of their dispersions or as isolated nanoparticles, for producing materials of the invention curable physically, thermally, with actinic radiation, and both thermally and with actinic radiation.

For the purposes of the present invention actinic radiation means electromagnetic radiation such as near infrared (NIR), visible light, UV radiation, x-rays or gamma radiation, especially UV radiation, and particulate radiation such as electron beams, beta radiation, alpha radiation, proton beams, and neutron beams, especially electron beams.

The curable materials of the invention are outstandingly suitable for producing thermoplastic and thermoset materials.

The curable materials of the invention are used preferably as coating materials, adhesives, sealants, and also precursors to moldings and films, for producing coatings, adhesive layers, seals, moldings, and films of the invention.

In particular the thermoplastic and thermoset materials, especially thermoset materials, of the invention are coatings, moldings, and films.

The coatings of the invention preferably are highly scratch-resistant, pigmented and unpigmented surface coatings, more preferably transparent, and in particular clear, clearcoats, moldings, especially optical moldings, and self-supporting films.

With very particular preference the surface coatings of the invention are highly scratch-resistant clearcoats, and also highly scratch-resistant clearcoats as part of multicoat color and/or effect paint systems, on customary and known substrates (in this regard cf. the international patent application WO 03/016411, page 41 line 6 to page 43 line 6 in conjunction with page 44 line 6 to page 45 line 6).

The production of the thermoplastic and thermoset materials of the invention from the curable materials of the invention has no peculiarities in terms of method but is instead carried out with the aid of customary and known processes and apparatus that are typical for the particular thermoplastic or thermoset material of the invention.

In particular the coating materials of the invention are applied to substrates with the aid of the customary and known processes and apparatus described in international patent application WO 03/016411, page 37 lines 4 to 24.

The curable materials of the invention can be cured as described in international patent application WO 03/016411, page 38 line 1 to page 41 line 4.

The curable materials of the invention provide thermoplastic and thermoset materials, especially thermoset materials, particularly surface coatings, especially clearcoats, moldings, especially optical moldings, and self-supporting films of the invention which are of high scratch resistance and chemical stability. In particular the surface coatings of the invention, especially the clearcoats, can be produced even in film thicknesses >40 μm without stress cracks appearing.

The thermoplastic and thermoset materials, especially thermoset materials, of the invention are therefore outstandingly suitable for use as highly scratch-resistant, decorative, protective and/or effect-imparting surface coatings on bodies of means of transport of any kind (particularly means of transport operated by muscle power, such as cycles, coaches or railroad trollies; motorized means of transport, such as aircraft, especially airplanes, helicopters or airships; floating structures, such as ships or buoys; rail vehicles, such as locomotives, railcars and railroad wagons; and also motor vehicles, such as motorcycles, buses, trucks or automobiles) or on parts thereof; on the interior and exterior of buildings; on furniture, windows, and doors; on plastic moldings, especially those of polycarbonate, particularly CDs and windows, especially windows in the automotive segment; on small industrial parts; on coils, containers, and packaging; on white goods; on films; on optical, electrical, and mechanical components; and also on hollow glassware and articles of everyday use.

The surface coatings of the invention, especially the clearcoats, can be employed in particular in the especially technologically and aesthetically demanding segment of automotive OEM finishing. There they are notable in particular for especially carwash resistance and scratch resistance, especially dry scratch resistance.

### EXAMPLE

### The Preparation of a Copolymer (A)

A steel reactor with a volume of five liters was charged with 1716.9 g of deionized water and this initial charge was heated to 90° C. Subsequently, at this temperature, three separate feed streams, commenced simultaneously, were metered in with stirring, at a uniform rate, over the course of 4 hours (feed 1), 3.75 hours (feed 2), and 4.5 hours (feed 3).

Feed 1 consisted of 47.7 g of acrylic acid, 75.3 g of 2-(acetoacetoxy)ethyl methacrylate (Lonzamon® AAEMA from Lonza), 199.5 g of methyl methacrylate, 267.3 g of 2-ethylhexyl methacrylate, 113 g of styrene, and 50.1 g of diphenylethylene.

Feed 2 consisted of 46.4 g of 25 percent strength ammonia solution and 232.2 g of deionized water.

Feed 3 was a solution of 75.5 g of ammonium peroxodisulfate in 176 g of water.

The end of the feeds (i.e., the end of feed 3) was followed by a three-hour postpolymerization at 90° C. This gave a yellowish white dispersion of the copolymer (A) with a pH of 4.7 and a solids content of 27% by weight (60 minutes/130° C.).

The dispersion of the copolymer (A) was outstandingly suitable as a crystallization inhibitor and dispersant for the preparation of deagglomerated barium sulfate nanoparticles.

1. A copolymer (A) of olefinically unsaturated monomers (a), prepared by single-stage or multistage controlled free-radical copolymerization in an aqueous medium of monomers comprising:
(a1) an olefinically unsaturated monomer comprising a chelate-forming group; and
(a2) an olefinically unsaturated monomer different from the olefinically unsaturated monomer (a1), and selected from the group consisting of:
(a21) monomers ofthe general formula I
R¹R²C═CR³R⁴ (I),
wherein R¹, R², R³, and R⁴ are independently hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of R¹, R², R³, and R⁴ are substituted or unsubstituted aryl, arylalkyl or arylcycloalkyl radicals;
(a22) an olefinically unsaturated terpene hydrocarbon; and
(a23) a dimeric alpha-alkylvinylaromatic.

2. The copolymer (A) of claim 1, wherein the chelate-forming group of the olefinically unsaturated monomer (a1) is at least bidentate.

3. The copolymer (A) of claim 1, wherein the chelate-forming group of the olefinically unsaturated monomer (a1) comprises two atomic groupings which act as electron donors.

4. The copolymer (A) of claim 3, wherein the atomic groupings are selected from the group consisting of carbonyl groups of formula >C═O, thiocarbonyl groups of formula >C═S, ether groups of formula —CH₂—O—CH₂—, thioether groups of formula —CH₂—S—CH₂—, primary, secondary, and tertiary amino groups of formula >C—NR⁵₂wherein R⁵ is independently a hydrogen atom or alkyl radical having 1 to 6 carbon atoms, primary and secondary imino groups of formula >C═NR⁵ wherein R⁵ is independently a hydrogen atom or alkyl radical having 1 to 6 carbon atoms, oxime groups of formula >C═N—O—H, imino ether groups of formula >C═N—O—R⁶ wherein R⁶=is an alkyl radical having 1 to 10 carbon atoms or cycloalkyl radical having 4 to 10 carbon atoms, and primary, secondary, and tertiary phosphine groups of formula —PR⁷₂ wherein R⁷ is independently a hydrogen atom or alkyl radical having 1 to 6 carbon atoms, cycloalkyl radical having 4 to 10 carbon atoms or aryl radical having 6 to 10 carbon atoms.

5. The copolymer (A) of claim 4, wherein the atomic groupings are the carbonyl groups of formula >C═O.

6. The copolymer (A) of claim 5, wherein the chelate-forming group is a 1,3-dicarbonyl groups.

7. The copolymer (A) of claim 1, wherein the olefinically unsaturated monomers (a1) comprises olefinically unsaturated groups selected from the group consisting of (meth)acrylate groups, ethacrylate groups, crotonate groups, cinnamate groups, vinyl ether groups, vinyl ester groups, dicyclopentadienyl groups, norbornenyl groups, isoprenyl groups, isopropenyl groups, allyl groups, butenyl groups, dicyclopentadienyl ether groups, norbornenyl ether groups, isoprenyl ether groups, isopropenyl ether groups, allyl ether groups, butenyl ether groups, dicyclopentadienyl ester groups, norbornenyl ester groups, isoprenyl ester groups, isopropenyl ester groups, allyl ester groups, butenyl ester groups and a combination thereof.

8. The copolymer (A) of claim 7, wherein the olefinically unsaturated groups are (meth)acrylate groups.

9. The copolymer (A) of claim 7, wherein the chelate-forming group is attached to the olefinically unsaturated group via at least one covalent bond or via an at least divalent linking group.

10. The copolymer (A) of claim 7, wherein the chelate-forming group is attached to the olefinically unsaturated group via a divalent linking group.

11. The copolymer (A) of claim 10, wherein the divalent linking group is an alkylene group.

12. The copolymer (A) of claim 1, wherein R¹, R², R³, R⁴, or a combination thereof are phenyl or naphthyl radicals.

13. The copolymer (A) of claim 12, wherein R¹, R², R³, R⁴, or a combination thereof are phenyl radicals.

14. The copolymer (A) of claim 1, wherein R¹, R², R³, R⁴, or a combination thereof comprise substituents selected from the group consisting of electron-withdrawing atoms, electron-donating atoms, electron-withdrawing organic radicals, electron-donating organic radicals, and a combination thereof.

15. The copolymer (A) of claim 14, wherein the substituents are selected from the group consisting of halogen atoms, nitrile radicals, nitro radicals, partially and fully halogenated alkyl, cycloalkyl, alkylcycloalkyl, cycloalkylalkyl, aryl, alkylaryl, cycloalkylaryl, arylalkyl and arylcycloalkyl radicals; aryloxy, alkyloxy, and cycloalkyloxy radicals; arylthio, alkylthio, and cycloalkylthio radicals; and primary, secondary, and tertiary amino groups.

16. The copolymer (A) of claim 1, wherein the olefinically unsaturated terpene hydrocarbon (a22) is selected from the group consisting of monocyclic terpenes, bicyclic terpenes, acyclic sesquiterpenes, monocyclic sesquiterpenes, bicyclic sesquiterpenes, tricyclic sesquiterpenes, acyclic diterpenes, monocyclic diterpenes, tricyclic diterpenes, and a combination thereof.

17. The copolymer (A) of claim 1, wherein the olefinically unsaturated terpene hydrocarbon (a22) is selected from the group consisting of acyclic monoterpenes, monocyclic terpenes, bicyclic terpenes, and a combination thereof.

18. The copolymer (A) of claim 1, wherein the olefinically unsaturated terpene hydrocarbon (a22) is selected from the group consisting of ocimene, myrcene, the menthenes, the menthadienes, alpha-pinene, beta-pinene, and a combination thereof.

19. The copolymer (A) of claim 18, wherein the menthadienes are selected from the group consisting of alpha-terpinene, beta-terpinene, gamma-terpinene, terpinolene, alpha-phellandrene, beta-phellandrene, limonene, dipentene, and a combination thereof.

20. The copolymer (A) of claim 19, wherein the menthadienes are selected from gamma-terpinene.

21. The copolymer (A) of claim 1, wherein the dimeric alpha-alkylvinylaromatic (a23) is a dimeric alpha-alkylstyrenes.

22. The copolymer (A) of claim 21, wherein the dimeric alpha-alkylstyrene is a dimeric alpha-methylstyrene.

23. The copolymer (A) of claim 1, wherein the monomers further comprise a different olefinically unsaturated monomer (a3).

24. A process for preparing a copolymer (A), comprising polymerizing by single-stage or multistage controlled free-radical copolymerization in an aqueous medium monomers, the monomers comprising:
(a1) an olefinically unsaturated monomer comprising a chelate-forming group; and
(a2) an olefinically unsaturated monomer different from the olefinically unsaturated monomer (a1), and selected from the group consisting of:
(a21) monomers ofthe general formula I
R¹R²C═CR³R⁴ (I),
wherein R¹, R², R³, and R⁴ are independently hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the R¹, R², R³, and R⁴ are substituted or unsubstituted aryl, arylalkyl or arylcycloalkyl radicals;
(a22) an olefinically unsaturated terpene hydrocarbon, and
(a23) a dimeric alpha-alkylvinylaromatic.

25. A method of inhibiting the crystallization of nanoparticles and/or dispersing nanoparticles, comprising adding the copolymer (A) of claim 1 to the nanoparticles.

26. The method of claim 25, wherein the nanoparticles are barium sulfate nanoparticles.

27. The method of claim 26, wherein the barium sulfate nanoparticles are deagglomerated barium sulfate nanoparticles.

28. The method of claim 27, wherein the deagglomerated barium sulfate nanoparticles have a primary particle size <50 nm.

29. Materials curable physically, thermally, with actinic radiation, or both thermally and with actinic radiation, comprising crystallization inhibited nanoparticles and/or dispersed nanoparticles prepared by adding the copolymer (A) of claim 1 to the nanoparticles.

30. Thermoplastic or thermoset materials comprising the curing product of the materials of claim 29.

31. The materials of claim 29, in the form of coating materials, adhesives, sealants or precursors to moldings or films.

32. The thermoplastic or thermoset materials of claim 30, in the form of coatings, adhesive layers, seals, moldings or films.
